(19) United States
(12) Patent Application Publication
(10) Pub. No.: US 2015/0301984 A1
(43) Pub. Date: Oct. 22, 2015

(54) SIGNAL DECOMPOSITION SYSTEM WITH LOW-LATENCY EMPIRICAL MODE DECOMPOSITION AND METHOD THEREOF

(71) Applicant: NATIONAL TAIWAN UNIVERSITY, Taipei (TW)

(72) Inventors: Wen-Chung SHEN, Taipei (TW); An-Yeu WU, Taipei (TW); Hsiao-I JEN, Taipei (TW)

(73) Assignee: NATIONAL TAIWAN UNIVERSITY, Taipei (TW)

(21) Appl. No.: 14/258,001

(22) Filed: Apr. 21, 2014

(51) Int. Cl. G06F 17/14

(52) U.S. Cl. CPC G06F 17/14

(57) ABSTRACT

A signal decomposition system with low-latency empirical mode decomposition and the method of the same decompose an original signal using iterative computations with different directions of data streams. The directions of data stream in computations of odd or even iterations are adjusted for reducing the number of data stream direction reversals. As a result, computing data can be shared and computing time can be saved. The mechanism helps improve the efficiency of signal decompositions.

### BACKGROUND OF RELATED ART

1. Technical Field

The invention relates to a signal decomposition system and the method thereof. In particular, the invention relates to a signal decomposition system with low-latency empirical mode decomposition that reduces the number of data stream directions in many computations. The invention also relates to the method for the same.

2. Related Art

In recent years, many experts apply the Hilbert-Huang transform to different fields, such as safety analysis in public engineering, disease diffusion analysis, voice recognition, natural disaster analysis, geophysical probes, satellite data analysis, biomedical data analysis, etc. In contrast to conventional Fourier transform or wavelet transform, the Hilbert-Huang transform is more effective in decomposing nonlinear signals for further analysis.

Generally speaking, the Hilbert-Huang transform utilizes empirical mode decomposition (EMD) to decompose an original signal into an intrinsic mode function (IMF) for subsequent analyses. However, since the EMD requires a huge amount of memory and the computation is complicated and time-consuming, there is a problem of low efficiency in signal decomposition.

In view of the foregoing, some vendors propose real-time computations on hardware. The very-large-scale integration (VLSI) architecture is employed to implement the EMD. Nevertheless, this method has the problem of high latency. Therefore, it still has the problem with lower signal decomposition efficiency.

In summary, there exists in the prior art the problem of low efficiency in signal decomposition. It is imperative to provide a good solution.

### SUMMARY

The invention discloses a signal decomposition system with low-latency EMD and the method of the same.

The disclosed system includes: a receiving module, a computing module, and an outputting module. The receiving module receives an original signal, and sets the original signal as input data. The computing module employs low-latency EMD to execute multiple computations with data stream directions for decomposing the original signal into an IMF, where consecutive two computations have opposite data stream directions. Each computation searches for a plurality of maxima and a plurality of minima, uses cubic-spline interpolation (CSI) to compute an upper envelope for the plurality of maxima and a lower envelope of the plurality of minima. The data stream directions are reversed. An average of the upper envelope and the lower envelope is computed. The input data and the average are used to produce a difference. When the number of difference productions satisfies a predetermined value of times, the difference is taken as an IMF. After obtaining the IMF, the original signal subtracts the IMF to obtain a residue, which is used as the input data to redo the computation until the residues becomes a monotonic function. After the multiple computations with the low-latency EMD, the outputting module outputs all the IMFs and the last residue.

The disclosed method includes the steps of: receiving an original signal and setting the original signal as input data employing low-latency EMD to execute multiple computations with data stream directions for decomposing the original signal into an IMF, wherein each consecutive computations involve opposite data stream directions and each computation includes the steps of: finding a plurality of maxima and a plurality of minima; using cubic-spline interpolation to compute an upper envelope of the plurality of maxima and a lower envelope of the plurality of minima, and making data stream directions opposite; computing an average of the upper envelope and the lower envelope; subtracting the average from the input data to generate a difference and, when the number of difference generations has not reached a predetermined value, using the difference as the input data for redoing the computation or, when the number of difference generations has reached the predetermined value, using the difference as the IMF; after generating the IMF, subtracting the IMF from the original signal to generate a residue and using the residue as the input data for redoing the computation until the residues become a monotonic function; outputting all of the IMFs and the residue from the last computation after completing a plurality of the above-mentioned low-latency EMD.

The disclosed system and method differ from the prior art in that the invention performs multiple iterative computations with different data stream directions to decompose the original signal. The data stream directions in odd-numbered and even-numbered computations are adjusted to reduce the number of data stream direction reversals. As a result, computing data can be shared and computing time can be saved.

Through the above-mentioned means, the invention achieves the goal of increasing signal decomposition efficiency.

### BRIEF DESCRIPTION OF THE DRAWINGS

The invention will become more fully understood from the detailed description given herein below illustration only, and thus is not limitative of the present invention, and wherein:

FIG. 1 is a system block diagram of the disclosed signal decomposition system with low-latency empirical mode decomposition;

FIGS. 2A and 2B is a flowchart of the disclosed signal decomposition method with low-latency empirical mode decomposition;

FIG. 3 is a schematic view of the disclosed hardware structure;

FIG. 4 shows the difference in the data stream directions in each computation between the prior art and the invention; and

FIG. 5 is a flowchart showing the detailed computation procedure of applying the invention on data with same stream direction.

### DETAILED DESCRIPTION

The present invention will be apparent from the following detailed description, which proceeds with reference to the accompanying drawings, wherein the same references relate to the same elements.

Before describing in detail the disclosed signal decomposition system and method with low-latency empirical mode decomposition (EMD), we first define terms used herein. Each computation mentioned in this specification includes the following steps:

(1) find a plurality of maxima and a plurality of minima;

(2) use cubic-spline interpolation (CSI) to compute an upper envelope for the plurality of maxima and a lower envelope for the plurality of minima, and reverse a data stream direction;

(3) compute an average for the upper envelope and the lower envelope;

(4) subtract the average from the input data to generate a difference and, when the number of difference generations is below a predetermined value, use the difference as the input for redoing the computation or, when the number of difference generations reaches the predetermined value, use the difference as an intrinsic mode function (IMF); and

(5) after obtaining the IMF, subtract the IMF from the original signal to generate a residue and use the residue as the input for redoing the computation until the residues becomes a monotonic function (that is, unable to further decompose the IMF into the components thereof).

In other words, after repeatedly executing the above-mentioned five steps, the original signal is decomposed into at least one IMF and one residue, and no further decomposition is possible.

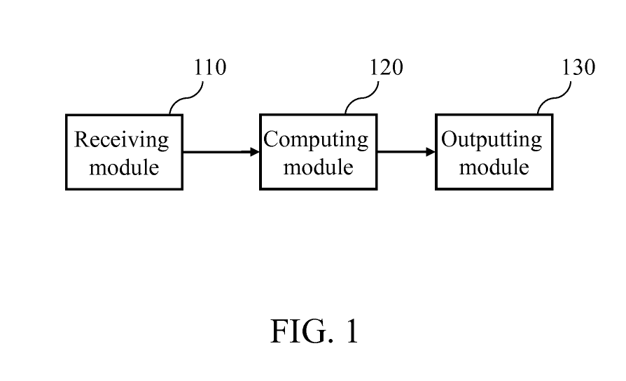

Please refer to FIG. 1 for a system block diagram of the disclosed signal decomposition system with low-latency empirical mode decomposition. The system includes: a receiving module 110, a computing module 120, and an outputting module 130. The receiving module 110 receives an original signal, which can be an unstable, nonlinear signal. The original signal is set as input data. That is, for the convenience of computing, the original signal is duplicated as the input data. In practice, we can denote the original signal by “x(t)” and the input data by “c(t)”. The input data will be modified repeatedly during the computation.

Through low-latency EMD, the computing module 120 executes multiple computations with different data stream directions to decompose the original signal into an IMF, where the data stream directions in each two consecutive computations are opposite. The data stream direction in each computation will be described with an accompanying figure later. It should be mentioned that each computation includes the steps of: finding extrema (i.e., a plurality of maxima and a plurality of minima); using the CSI to compute an upper envelope for the plurality of maxima and a lower envelope for the plurality of minima, and reversing the data stream direction (e.g., changing the original left-to-right data stream direction to right-to-left); computing an average of the upper envelope and the lower envelope; subtracting the average from the input data to generate a difference and, when the number of difference generations is below a predetermined value, taking the difference as the input data for redoing the computation or, when the number of difference generations reaches the predetermined value, taking the difference as the IMF; after obtaining the IMF, subtracting the IMF from the original signal to generate a residue and using the residue as the input data for redoing the computation until the residues become a monotonic function. In practice, the predetermined value can be set as 10 before performing the multiple computations. The CSI can employ a tridiagonal matrix to perform forward and backward operations of Gauss elimination. The tridiagonal matrix has the following form:

$$[ \begin{matrix}{B}_{1} & {C}_{1} & 0 & L & 0 \\ {A}_{2} & {B}_{2} & {C}_{2} & O & M \\ 0 & {A}_{3} & {B}_{3} & O & 0 \\ M & O & O & O & {C}_{n - 1} \\ 0 & L & 0 & {A}_{n} & {B}_{n}\end{matrix} ] [ \begin{matrix}{S}_{2} \\ {S}_{3} \\ {S}_{4} \\ M \\ {S}_{n + 1}\end{matrix} ] = [ \begin{matrix}{D}_{1} \\ {D}_{2} \\ {D}_{2} \\ M \\ {D}_{n}\end{matrix} ]$$

During the calculation, one first performs the Gauss elimination in the forward direction for the lower tridiagonal matrix, followed by the Gauss elimination in the backward direction for the upper tridiagonal matrix. Since the data stream directions of the consecutive two operations are reversed, the data stream direction in the later half of the first operation is the same as that in the first half of the second operation, the data in these two operations for forward Gauss elimination, finding extrema, and backward Gauss elimination can be shared.

After completing the multiple computations of the low-latency EMD, the outputting module 130 outputs all of the IMFs and the residue generated during the last computation. In practice, the output IMFs and the last residue can be used in the Hilbert-Huang transform.

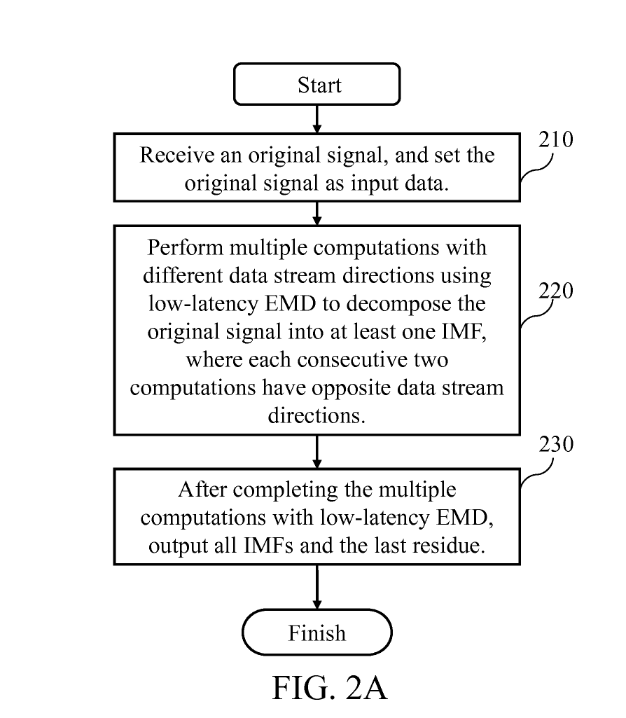

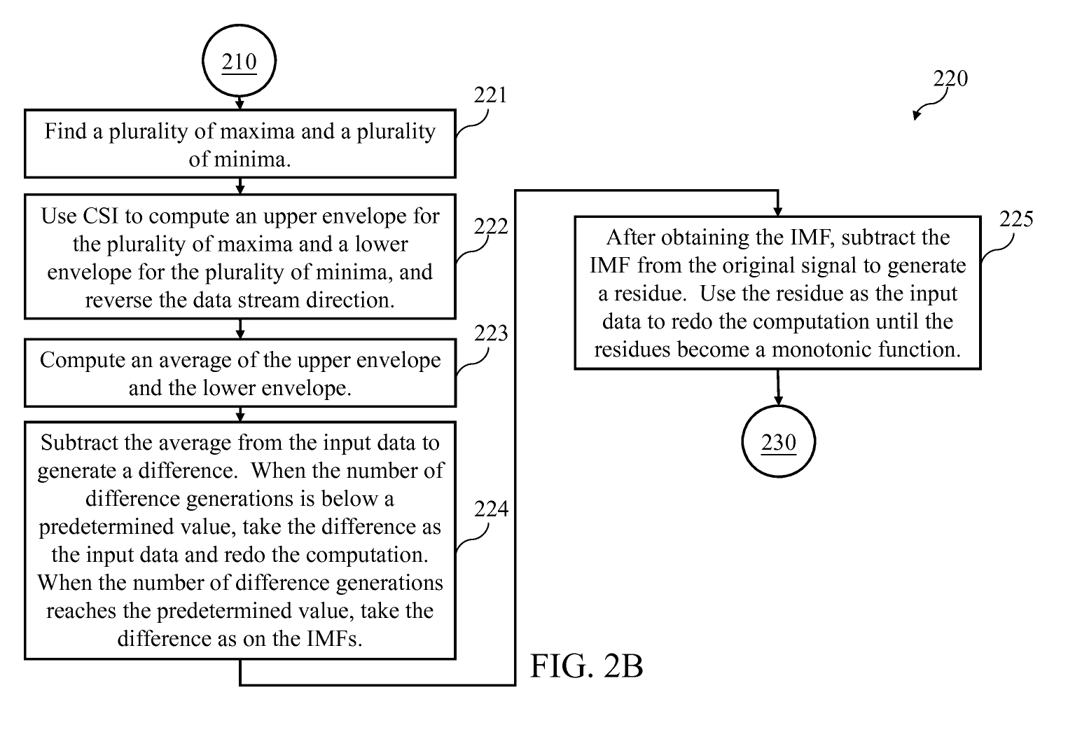

Please refer to FIGS. 2A and 2B for a flowchart of the disclosed signal decomposition method with low-latency empirical mode decomposition. The disclosed method includes the steps of: receiving an original signal and setting the original signal as input data (step 210); using low-latency EMD to execute multiple computations with different data stream directions to decompose the original signal into an IMF, where the data stream directions in each consecutive two computations are opposite (step 220); after completing the multiple computations of low-latency EMD, outputting all the IMFs and the residue generated in the last computation (step 230). It should be mentioned that each computation in step 220 includes the steps of: finding a plurality of maxima and a plurality of minima (step 221); using the CSI to compute an upper envelope for the plurality of maxima and a lower envelope for the plurality of minima, and reversing a data stream direction (step 222); computing an average of the upper envelope and the lower envelope (step 223), subtracting the average from the input data to generate a difference and, when the number of difference generations is below a predetermined value, taking the difference as the input data for redoing the computation or, when the number of difference generations reaches the predetermined number, taking the difference as one of the IMFs (step 224); after obtaining the IMF, subtracting the IMF from the original signal to generate a residue, and using the residue as the input data for redoing the computation until the residues become a monotonic function (step 225). Through the above-mentioned steps, the original signal is decomposed after multiple iterative computations with different data stream directions. The data stream directions of odd-numbered and even-numbered computations are adjusted to reduce the number of data stream direction reversals. The computing data can be shared to save computing time.

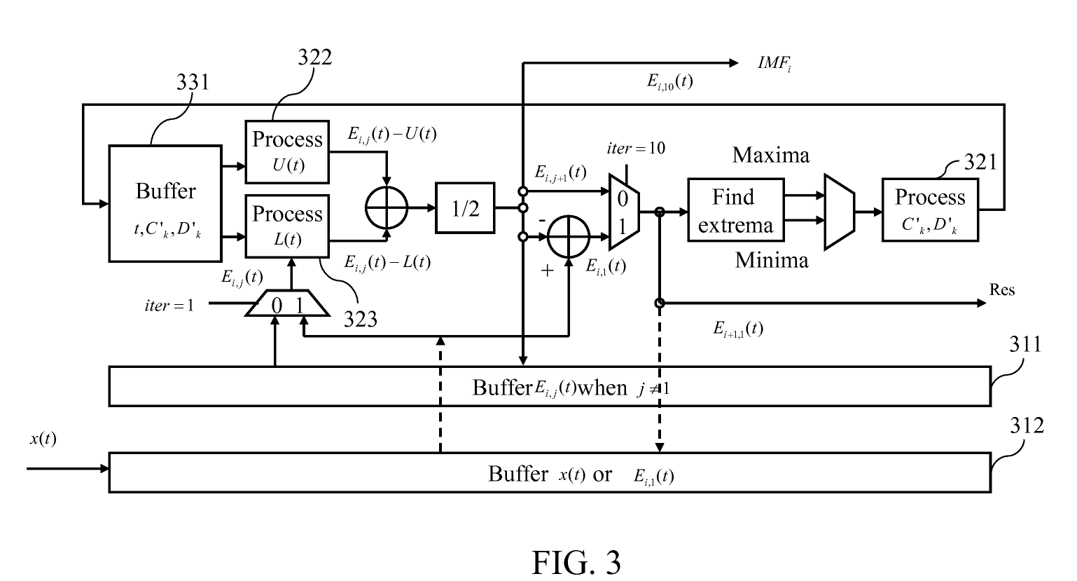

In the following, an embodiment is used to elucidate the invention with reference to FIGS. 3 to 5. Please first refer to FIG. 3 for a schematic view of the disclosed hardware structure. This structure can be called a ping-pong structure, where “E_{i,j}” denotes the input data before the i-th input component subtracts the average in the j-th computation, “iter” the number of iterations, “x(t)” the original signal, “IMᵢ” the i-th IMF, and “Res” the residue generated from the last computation. There are high-frequency (HF) and low-frequency (LF) storage devices (e.g., HF memory 311 and LF memory 312) to store HF data and LF data, respectively. Processing units (PU's) 321-323 are used for the computations. A buffer 331 temporarily holds data generated during the computations.

When the EMD starts, the input data are loaded from the LF memory in order to find the extrema (including a plurality of maxima and a plurality of minima). The PU's employ the tridiagonal matrix algorithm (TDMA) to compute “C′ₖ,D′ₖ”, which are then stored in the buffer. Afterwards, “C′ₖ,D′ₖ” are used to compute the upper envelope “U(t)” of the plurality of maxima and the lower envelope “L(t)” of the plurality of minima. Moreover, the average of the upper envelope and the lower envelope is computed for average removal (subtracting the average from the input data). Suppose the predetermined value of computations is set as 10. During the first to the ninth computations, computed results “E_{i,j+1}(t)” are stored in the HF memory. During the tenth computation, the computed result “E_{i,j+1}(t)” is output as an IMF. The average removal “E_{i,1}(t)−E_{i,j+1}(t)” of the tenth iteration is stored in the LF memory and set as the input of the next IMF. Using this hardware structure, the original signal can be decomposed after multiple computations, thereby outputting at least one IMF and the last residue, represented by

$$“ x ( t ) = {\sum }_{i = 1}^{M} {C}_{i} ( t ) + Res ( t ) ” ,$$

where “x(t)” is the original signal, “M” the number of IMFs, “Cᵢ(t)” the i-th IMF, and “Res(t)” the last residue. It is then provided for Hilbert-Huang transforms.

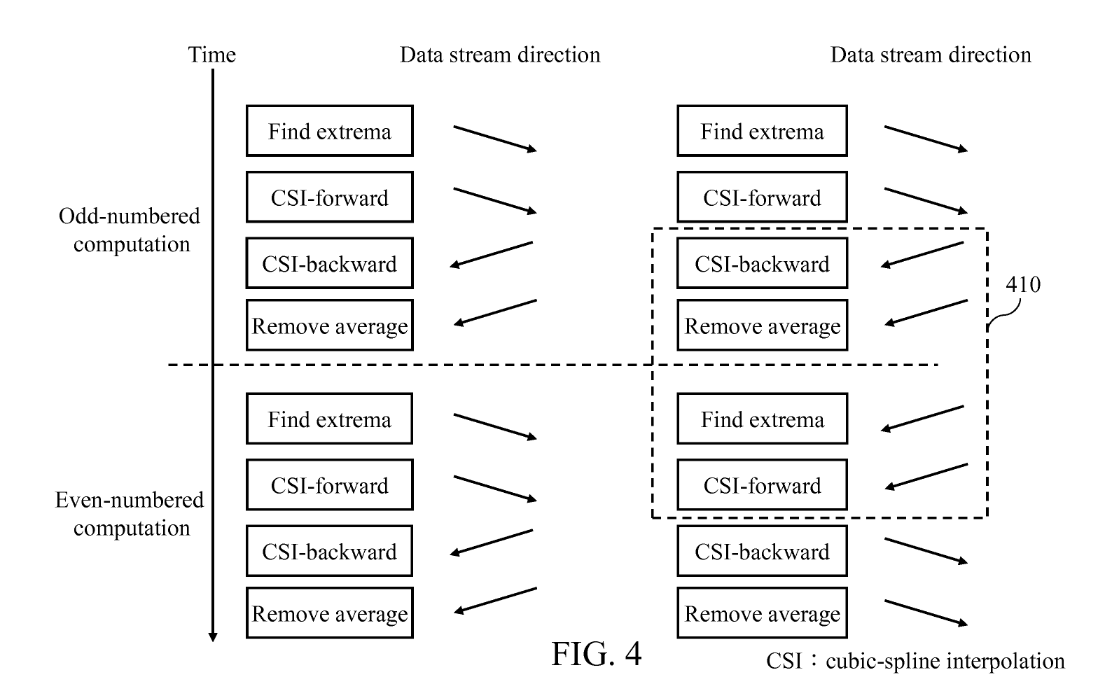

FIG. 4 shows the difference in the data stream directions in each computation between the prior art and the invention. First, each computation involves the steps of: finding extrema, CSI-forward, CSI-backward, and average removal. Each step has a corresponding data stream direction, which is reversed during the CSI calculation. In the figure, the left-hand side shows the data stream directions in the prior art, where the directions in odd-numbered and even-numbered computations are exactly the same. The right-hand side shows the data stream directions in the invention. It is clear from the drawing that the even-numbered computations of the invention have opposite data stream directions from those of the prior art. In other words, each consecutive two computations have opposite data stream directions, as indicated by the steps in the dashed line 410. The data stream directions of CSI-backward and average removal in the odd-numbered computations of the invention are the same as those of finding extrema and CSI-forward in the even-numbered computations. As a result, computing data can be shared to optimize the CSI, effectively reducing computing time.

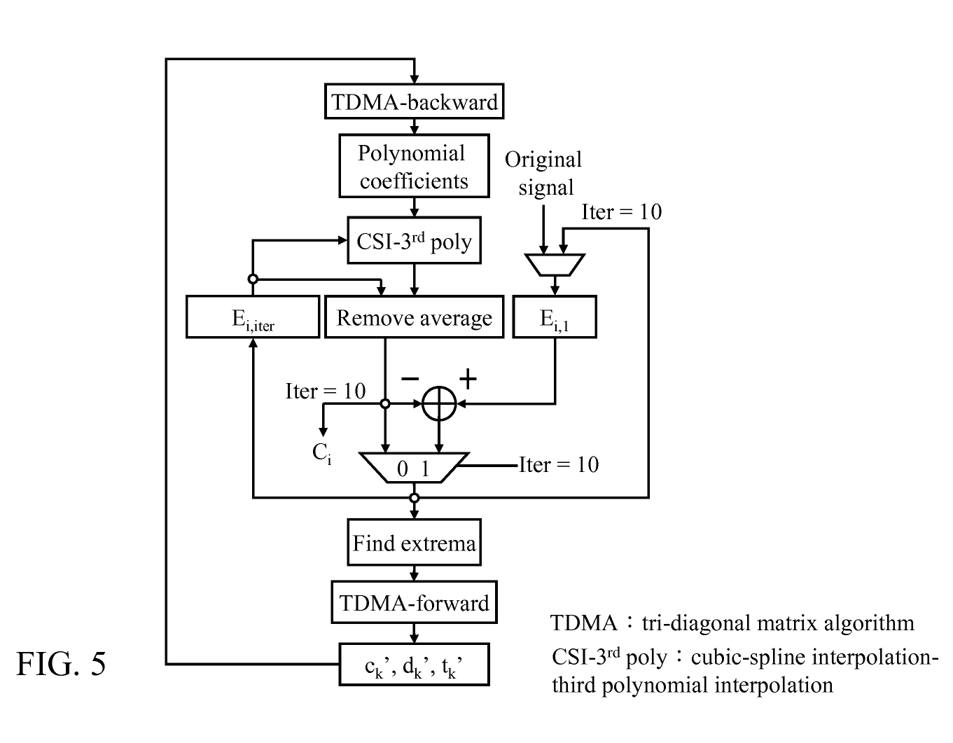

Please refer to FIG. 5 for a flowchart showing the detailed computation procedure of applying the invention on data with same stream direction. First, the original signal is entered and set as the input data. It is analyzed to find the extrema (including a plurality of maxima and a plurality of minima). The TDMA is employed to compute the polynomial coefficients of the cubic polynomial envelopes of the plurality of maxima and the plurality of minima using forward Gauss elimination and backward Gauss elimination. Afterwards, the average of the upper envelope and the lower envelope is removed to generate the difference. The computation of one difference is completed up to this point. When the number of difference generations is below a predetermined value (e.g. 10), the difference is taken as the input data for redoing the computation from the beginning (i.e., finding the extrema). On the other hand, if the number of difference generations reaches the predetermined value, then the difference is taken as one of the IMFs (Cᵢ). This IMF is then subtracted from the original signal to generate the residue (Eᵢ). The residue is taken as the input for redoing the computation from the beginning, until the decomposition of the original signal is completed. The residue generated during the last computation is output. It should be mentioned that both “TDMA-forward” and “TDMA-backward” represent operations with the tridiagonal matrix, i.e., the forward and backward operations of the TDMA. “CSI-3^{rd}poly” refers to the cubic polynomial interpolation using a cubic spline. The CSI contains at the same time the “TDMA-forward”, “TDMA-backward”, and “CSI-3^{rd}poly” operations.

In summary, the invention differs from the prior art in that the original signal is decomposed through multiple iterations with different data stream directions. The data stream directions of odd-numbered and even-numbered computations are adjusted to reduce the number of data stream direction reversals. As a result, computing data can be shared and computing time can be saved. The mechanism solves the problems in the prior art and helps improve the efficiency of signal decompositions.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A signal decomposition system with low-latency empirical mode decomposition (EMD), comprising:
a receiving module, for receiving an original signal and setting the original signal as input data;
a computing module, for executing a plurality of computations with different data stream directions using low-latency EMD to decompose the original signal into at least one intrinsic mode function (IMF), wherein the data stream directions of each consecutive two computations are opposite and each computation includes the steps of:
finding a plurality of maxima and a plurality of minima;
using cubic-spline interpolation (CSI) to compute an upper envelope for the plurality of maxima and a lower envelope for the plurality of minima and reversing the data stream direction;
computing an average of the upper envelope and the lower envelope;
subtracting the average from the input data to generate a difference and, when the number of difference generations is below a predetermined value, taking the difference as the input data for redoing the computation or, when the number of difference generations reaches the predetermined value, taking the difference as one of the IMFs; and
after obtaining the IMF, subtracting the IMF form the original signal to generate a residue and taking the residue as the input data for redoing the computation until the residues become a monotonic function; and
an outputting module, for outputting all of the IMFs and the residue generated from the last computation after the plurality of computations with low-latency EMD are finished.

2. The signal decomposition system with low-latency EMD of claim 1, wherein the CSI employs a tridiagonal matrix to perform forward and backward Gauss eliminations.

3. The signal decomposition system with low-latency EMD of claim 1, wherein the data stream directions include from left to right and from right to left, and the data stream directions are reversed during the CSI calculation.

4. The signal decomposition system with low-latency EMD of claim 1, wherein the predetermined value is at least ten and is set before performing the plurality of computations.

5. The signal decomposition system with low-latency EMD of claim 1, wherein the original signal is an unstable, nonlinear signal.

6. A signal decomposition method with low-latency EMD, comprising the steps of: receiving an original signal and setting the original signal as input data;
executing a plurality of computations with different data stream directions with low-latency EMD to decompose the original signal into at least one IMF, wherein each consecutive two computations have opposite data stream directions and each of the computations includes the steps of:
finding a plurality of maxima and a plurality of minima;
using CSI to compute an upper envelope for the plurality of maxima and a lower envelope for the plurality of minima and reversing the data stream direction;
computing an average of the upper envelope and the lower envelope;
subtracting the average from the input data to generate a difference and, when the number of difference generations is below a predetermined value, using the difference as the input data for redoing the computation or, when the number of difference generations reaches the predetermined value, using the difference as one of the IMFs; and
after obtaining the IMF, subtracting the IMF from the original signal to generate a residue and using the residue as the input data for redoing the computation until the residues become a monotonic function; and
after completing the plurality of computations with low-latency EMD, outputting all of the IMFs and the residue generated from the last computation.

7. The signal decomposition method with low-latency EMD of claim 6, wherein CSI employs a tridiagonal matrix to perform forward and backward Gauss eliminations.

8. The signal decomposition method with low-latency EMD of claim 6, wherein the data stream directions include from left to right and from right to left, and the data stream directions are reversed during the CSI calculation.

9. The signal decomposition method with low-latency EMD of claim 6, wherein the predetermined value is at least ten and is set before performing the plurality of computations.

10. The signal decomposition method with low-latency EMD of claim 6, wherein the original signal is an unstable, nonlinear signal.
